(19) United States
(12) Patent Application Publication
(10) Pub. No.: US 2002/0088361 A1
(43) Pub. Date: Jul. 11, 2002

(54) Lecture note-taking method

(76) Inventor: Terence G. Morgan, Medford, NY (US)

Correspondence Address: MYRON AMER, P.C., Suite 310, 114 Old Country Road, Mineola, NY, 11501, US

(21) Appl. No.: 09/755,519

(22) Filed: Jan. 8, 2001

(51) Int. Cl. B41K 1/56; B41C 1/00

(52) U.S. Cl. 101/483; 101/405

(57) ABSTRACT

For use at a chemistry lecture in which frequent mention is made of the benzene ring, a note-taking method which keeps up in pace to the oral pace of the lecturer by ink stamping the chemical symbol of the benzene ring using the non-writing hand and adding appropriate written notations with the writing hand adjacent the stamp impressions, so that the tedium and time consumed in hand duplication of the benzene ring is obviated.

The present invention relates generally to note taking by a student attendee at a lecture focused on chemistry and, more particularly, to the use of a benzene ring ink stamp to enable the student to avoid tedium, produce more legible notes and to keep abreast in pace with the oral pace in which the lecture is delivered.

### EXAMPLE OF THE PRIOR ART

In U.S. Pat. No. 4,452,142 for “Multiple Head Rubber Stamp” issued to Eckels on Jun. 8, 1984, on a printed geographical map for showing locations of gas wells, an ink stamp providing an agreed upon graphic impression of which it is deemed to represent a gas well is applied to the map at each one of the qualifying locations, thereby obviating the tedium of duplicating a hand-drawn gas well graphic at each of the locations. The ink stamps thusly used obviates the tedium of duplication, but is otherwise of limited benefit.

Broadly, it is an object of the present invention to significantly contribute to the utility of ink stamp usage, to thereby overcome the foregoing and other shortcomings of the prior art. That is, the ink stamping of the '142 patent has no imposed time constraint and can be practiced whenever time permits and at any selected pace, and thus has attendant corresponding shortcomings for any use beyond that specified.

More particularly, it is an object to use ink stamping beyond obviating duplication tedium, but also to improve student note taking at chemistry lectures to enable a student attendee to keep abreast in pace of the pace at which the oral lecture is being delivered. as well as to otherwise achieve other noteworthy benefits in his/her note taking, all as will be better understood as the description proceeds.

The description of the invention which follows, together with the accompanying drawings should not be construed as limiting the invention to the example shown and described, because those skilled in the art to which this invention appertains will be able to devise other forms thereof within the ambit of the appended claims.

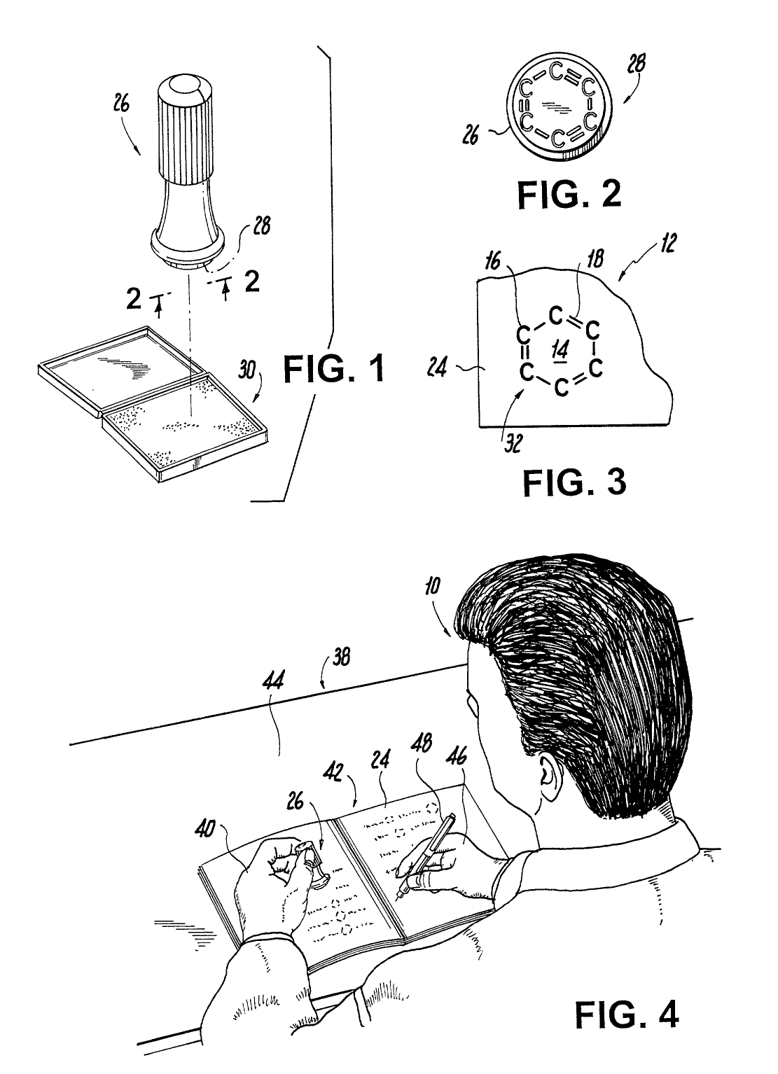

FIG. 1 is a perspective view of a stamp and stamp pad used in the practice of a note taking method of the present invention;

FIG. 2 is a bottom view taken in the direction of the arrows 2-2 of FIG. 1 of the stamp;

FIG. 3 is a plan view of the impression of the stamp;

FIG. 4 is a perspective view illustrating the method of note taking using the application of the stamp impression of FIG. 2 and hand notations; and

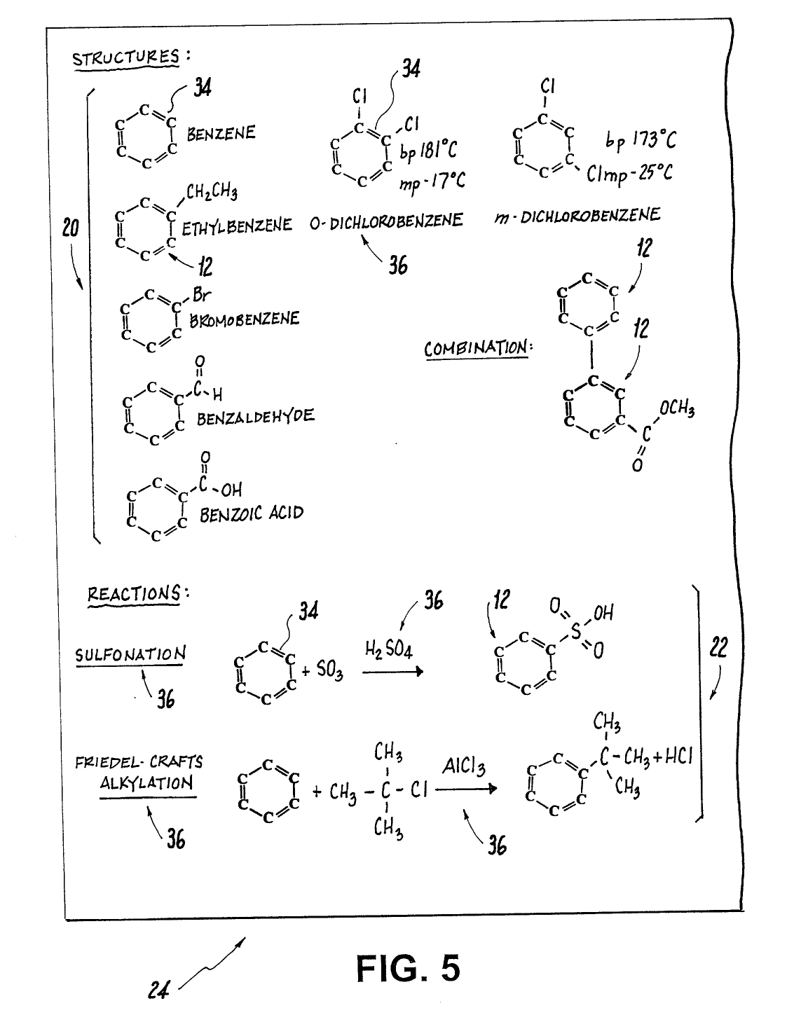

FIG. 5 is an illustration of a typical notebook page resulting from the FIG. 4 note taking method.

This invention is intended to facilitate note taking by a student attendee 10 at a lecture specifically focused on the field of chemistry during which it will be understood the lecturer will typically make frequent mention of a benzene ring generally designated 12, of a known molecular structure comprised of a circular circumferentially spaced apart arrangement, generally designated 14 of carbon atoms, individually and collectively designated by the letter “C” and in the spaces 16 between the letter “C” having bond lines, individually and collectively designated 18, indicating electron sharing which consists, as illustrated in FIG. 3 of alternating double and single lines.

The frequent mention noted is because a benzene ring 12 is involved in numerous chemical structures, as noted at 20 in FIG. 5 and in reactions, likewise as noted at 22, and heretofore duplication of the benzene ring 12 by hand on a notebook page 24 as illustrated in FIG. 5, was tedious and time consuming. To obviate this tedium and to enable note taking at a speed keeping up with the speed of the oral delivery of the information by the lecturer to the student audience, the benzene ring 12 on the student's notebook page 24 of FIG. 5 is applied using a hand stamp 26, the bottom 28 of which is inked when necessary by a stamp pad 30, so that it applies an ink impression 32 of FIG. 3 in the locations individually and collectively designated 34, and only supplementing notations, as at 36, are hand applied by the student 10.

More particularly, as illustrated in FIG. 4, a student 10 in his/her lecture hall seated position behind a desk 38 will use a stamping hand 40 to apply the benzene ring impressions 32 on a notebook 42, page 24, supported on the desk surface 44, and use a writing hand 46 only to make the supplementing commentary or notations 36 with a pen 48.

While the apparatus for practicing the within inventive method, as well as said method herein shown and disclosed in detail is fully capable of attaining the objects and providing the advantages hereinbefore stated, it is to be understood that it is merely illustrative of the presently preferred embodiment of the invention and that no limitations are intended to the detail of construction or design herein shown other than as defined in the appended claims.

What is claimed is:

1. In note taking by a student attendee at a lecture in the field of chemistry during which there is frequent mention of a benzene ring of a know molecular-illustrated structure and the inscribing during said note taking at selected mentions of said benzene ring said molecular-illustrated structure, an improved method of making inscriptions of said benzene ring said molecular-illustrated structure in conjunction with note taking commentary comprising the steps of:
A. using on a support a paper substrate having a writing surface in facing relation to a student lecture attendee;
B. impressing with one hand by said student using a stamp of a transferred circular circumferentially spaced apart arrangement of carbon atoms identified by the letter “C” and in the spaces between the letters “C” having bond lines indicating electron sharing which consists of alternating double and single lines onto said paper substrate writing surface; and
C. handwriting lecture commentary onto said paper substrate writing surface with the other hand by said student adjacent a said benzene ring transferred molecular-illustrated structure;
whereby note taking is facilitated by the coordinated use of the stamping and handwriting occupied hands of said student.
